(19) United States
(12) Patent Application Publication
(10) Pub. No.: US 2012/0267008 A1
(43) Pub. Date: Oct. 25, 2012

(54) Lathe Parting Tool

(76) Inventor: Stuart Batty, Boulder, CO (US)

(21) Appl. No.: 13/453,912

(22) Filed: Apr. 23, 2012

Related U.S. Application Data
(60) Provisional application No. 61/478,349, filed on Apr. 22, 2011.

(51) Int. Cl. B27G 15/00; B23P 15/28

(52) U.S. Cl. 142/56; 76/119

(57) ABSTRACT

This parting tool is compromised of a cutting blade with indexed depth markings allowing the depth of the cut to measured from the blade and a cutting blade housing that secures the blade such that the blade can extend, retract, and be easily removed from the housing. The housing and the blade have a coplanar bottom surface providing for reduced vibration and uninhibited movement of the tool across a tool rest. The blade and housing are secured in a vibration dampening bolster that can be removably attached to handles of various dimensions.

### CROSS REFERENCE TO RELATED APPLICATIONS

This application claims the benefit of U.S. Provisional Patent Application No. 61/478,349, filed on Apr. 22, 2012, which is incorporated by reference herein in its entirety for all purposes.

### BACKGROUND OF THE INVENTION

1. Field of the Invention

Embodiments of the present invention relate to woodturning tools of various kinds and types that are mounted into handles of varying lengths and are then used in a hand-held manner for the cutting, or parting-off, of the stock or workpiece while that workpiece is being rotated on a lathe.

2. Description of Related Art

The following discussion will discuss parting tools as a woodturning tool; however, this invention is not limited to use in the context of woodturning and may be used in metal working or other trades. Tools for the parting-off of wood, or parting tools, are commonly used by woodturners. The primary purpose of a parting tool is to make a kerf in the revolving workpiece. This kerf has only two size characteristics: width and depth. Woodturners today typically use a parting tool which incorporates a single blade inserted into a wooden handle. The blade's cross-section is most commonly a vertical rectangular or a vertical diamond-shaped hexagon. There are also thin-kerf designs which are typically tall and narrow rectangles, often without a handle; there are also some trapezoidal designs which are usually wider.

None of the currently available tools incorporate a blade design which contains an index that can be used to accurately gauge the depth of a cut. None of the currently available parting tools offer a blade and housing, which in conjunction, provide the ability to easily and quickly alter the blade length so that the depth of a cut can be increased or decreased. None of the currently available parting tools incorporate a coplanar blade and housing which reduces vibration. None of the currently available parting tools incorporate an asymmetric design on the distal end of the blade housing that provides an accurate means measuring the depth of the cut. None of the currently available parting tools incorporate a strengthening bolster for the tool shaft that includes a vibration damping material such as flake graphite cast iron. None of the currently available parting tools offer an easily replaceable or changeable handle and cutting blade and bolster.

### SUMMARY

According to embodiments of the present invention; a parting tool compromised of a multitude of pieces: a cutting blade housing, a moveable and replaceable cutting blade with indexed depth markings, a stabilizing bolster, and a removable handle. The blade is secured in the housing forming the cutting blade assembly such that the bottom of the housing and the bottom of the blade are coplanar, thus providing uninhibited movement of the tool across the lathe tool rest as it enters the rotating workpiece.

The indexed markings on the face of the blade along with the asymmetric design of the distal end of the housing pieces together provide a means of accurately measuring the depth of the cut of the tool. The design of the housing and the cutting blade provide for easy blade replacement after completion of its service life as well as the utilization of alternate blades for changing either the cutting widths or the available range of cutting depths.

The cutting blade assembly is secured in a reinforcing bolster which provides structural support and further dampens vibration from the cutting edge and reduces vibration transfer to the handle. The bolster also provides a means for removable attachment of the cutting blade assembly to handles of alternate diameters or lengths based on user preference. The bolster can be fitted into handles utilizing an internal threaded connection or some other connection mechanism. According to embodiments of the present invention, the bolster may be made of pearlitic matrix flake graphite cast iron thereby fortifying the strength of the tool, dampening vibration within the tool, and reducing vibration transfer to the handle of the tool.

Embodiments of this invention also encompass a method for manufacturing a parting tool by forming a cutting blade with multiple sides; putting indexed markings along the length of at least one side of the cutting blade; forming a cutting blade housing having multiple sides, wherein the cutting blade is housed; inserting the cutting blade into the cutting blade housing; securing the cutting blade in the cutting blade housing such that the cutting blade can be extended, retracted, and removed from the cutting blade housing; forming a handle; and removably attaching the cutting blade housing to the handle.

The method of paragraph [0008], wherein the bottom side of the cutting blade housing is formed to be coplanar with the bottom side of the cutting blade.

The method of paragraph [0008], wherein forming the cutting blade housing comprises forming an asymmetrical distal end, such distal end may be curved.

The method of paragraph [0008], wherein the removable attachment of the cutting blade housing to the handle comprises: forming a bolster; removably attaching the cutting blade housing to the bolster; removably attaching the bolster to the handle. Such bolster may be comprised of a vibration dampening material.

While multiple embodiments are disclosed, still other embodiments of the present invention will become apparent to those skilled in the art from the following detailed description which shows and describes illustrative embodiments of the invention. Accordingly, the drawings and detailed description are to be regarded as illustrative in nature and not restrictive.

### OBJECTS AND ADVANTAGES

None of the particular objects or advantages that follow must be entirely satisfied as they are non-exclusive alternatives and at least one of the following objects is met; accordingly, several objects and advantages of the present invention are:
(a) to provide a cutting blade which incorporates one or more index markings along the length of the cutting blade, providing an easily measureable scale for measuring the depth of a cut;
(b) to provide a replaceable cutting blade made of abrasion resistant material;
(c) to provide a housing for an indexed cutting blade that securely holds the blade, then inserting the cutting blade in the housing, wherein the cutting blade may be extended, retracted, or fixed into place; thereby allowing for variable depth of cut, extending the useful life of the blade, and allowing the blade to be easily replaced;
(d) to provide a housed blade tool that does not have a planar discontinuity along the bottom surface that contacts a tool rest, thereby reducing vibration and making the tool easier and more accurate to use;
(e) to provide an asymmetric design on the distal end of the blade housing that allows for an accurate means of viewing the index markings on the cutting blade;
(f) to provide a bolster that accepts the proximal ends of the blade and housing of the cutting blade assembly and allows for quick replacement and accommodation of cutting blade assemblies of various widths, depths, and lengths;
(g) to provide a handle that that allows for quick replacement of bolsters;
(h) to provide a blade made in whole or in part of a highly durable material;
(i) to provide a method for manufacturing a parting tool;
(j) these and other objects and advantages of the invention will be apparent from the detailed description and drawings.

### BRIEF DESCRIPTION OF THE DRAWINGS

1. Figures

FIG. 1 (on Sheet 1) illustrates an isometric perspective view of a complete parting tool, according to embodiments of the present invention.

FIG. 2 (on Sheet 1) illustrates an isometric perspective view showing the separation of a cutting blade assembly in a bolster separate from a handle, according to embodiments of the present invention.

FIG. 3 (on Sheet 1) illustrates a closer isometric perspective view showing only a cutting blade assembly in a bolster, according to embodiments of the present invention.

FIG. 4 (on Sheet 2) illustrates a side view of a parting tool with a cutting blade 10 fully retracted, according to embodiments of the present invention.

FIG. 5 (on Sheet 2) illustrates a side view of a parting tool with a cutting blade 10 fully extended, according to embodiments of the present invention.

FIG. 6 (on Sheet 2) illustrates a side view of a parting tool cutting blade 10, according to embodiments of the present invention.

FIG. 7 (on Sheet 2) illustrates an isometric perspective view of a parting tool cutting blade 10, according to embodiments of the present invention.

FIG. 8 (on Sheet 3) illustrates a distal end view of the right side of a cutting blade housing piece 22, according to embodiments of the present invention.

FIG. 9 (on Sheet 3) illustrates a distal end view of a cutting blade 10, according to embodiments of the present invention.

FIG. 10 (on Sheet 3) illustrates a distal end view of the left side of a cutting blade housing piece 23, according to embodiments of the present invention.

FIG. 11 (on Sheet 3) illustrates a distal end view of a cutting blade assembly, according to embodiments of the present invention.

FIG. 12 (on Sheet 3) illustrates a distal end view of a cutting blade assembly and bolster, according to embodiments of the present invention.

FIG. 13 (on Sheet 4) illustrates an exploded distal end view of a cutting blade assembly, according to embodiments of the present invention.

FIG. 14 (on Sheet 4) illustrates a distal end view of a cutting blade assembly bolster, according to embodiments of the present invention.

FIG. 15 (on Sheet 4) illustrates an exploded isometric perspective view of a cutting blade assembly and bolster, according to embodiments of the present invention.

FIG. 16 (on Sheet 5) illustrates a side view of a parting tool in use, cutting a tenon 61 on the end of a wooden workpiece 60, according to embodiments of the present invention.

FIG. 17 (on Sheet 5) illustrates an isometric perspective view of a parting tool in use, cutting a tenon 61 on the end of a wooden workpiece 60, according to embodiments of the present invention.

FIG. 18 (on Sheet 6) illustrates a side view of a parting tool in use, cutting a slot to a specific depth, according to embodiments of the present invention.

FIG. 19 (on Sheet 6) illustrates an isometric perspective view of a parting tool in use, cutting slots 62 to specific depths, according to embodiments of the present invention.

### 2. REFERENCES

10 Cutting blade.
11 Cutting blade index depth markings.
19 Asymmetrical distal end of the cutting blade housing 20
20 Cutting blade housing.
21 Cutting blade securing bolt.
22 Cutting blade housing's right face.
23 Cutting blade housing's left face.
24 Cutting blade securing nut.
25 Bottom side of the cutting blade assembly.
26 Cutting blade housing's right face locating ribs.
27 Cutting blade right face locating grooves.
28 Cutting blade housing's left face locating ribs.
29 Cutting blade left face locating grooves.
30 Cutting blade assembly bolster.
31 Mortise in the bolster for the cutting blade assembly.
40 Handle.
50 Lathe tool rest.
60 Turned wood workpiece.
61 Turned tenon on the end of a wooden workpiece.
62 Created slots in the turned wood workpiece

### DETAILED DESCRIPTION OF A PREFERRED EMBODIMENT

For the purposes of promoting an understanding of the principles of the invention, reference will now be made to the embodiments illustrated in the drawings and specific language will be used to describe the same. However, the illustrated embodiments are merely exemplary and many additional embodiments of this invention are possible. For example, a woodturning parting tool is pictured; however, this invention could be used for metal working. It is understood that no limitation of the scope of the invention is thereby intended. Any alterations and further modifications in the illustrated devices, and such further application of the principles of the invention as illustrated herein are contemplated as would normally occur to one skilled in the art to which the invention relates.

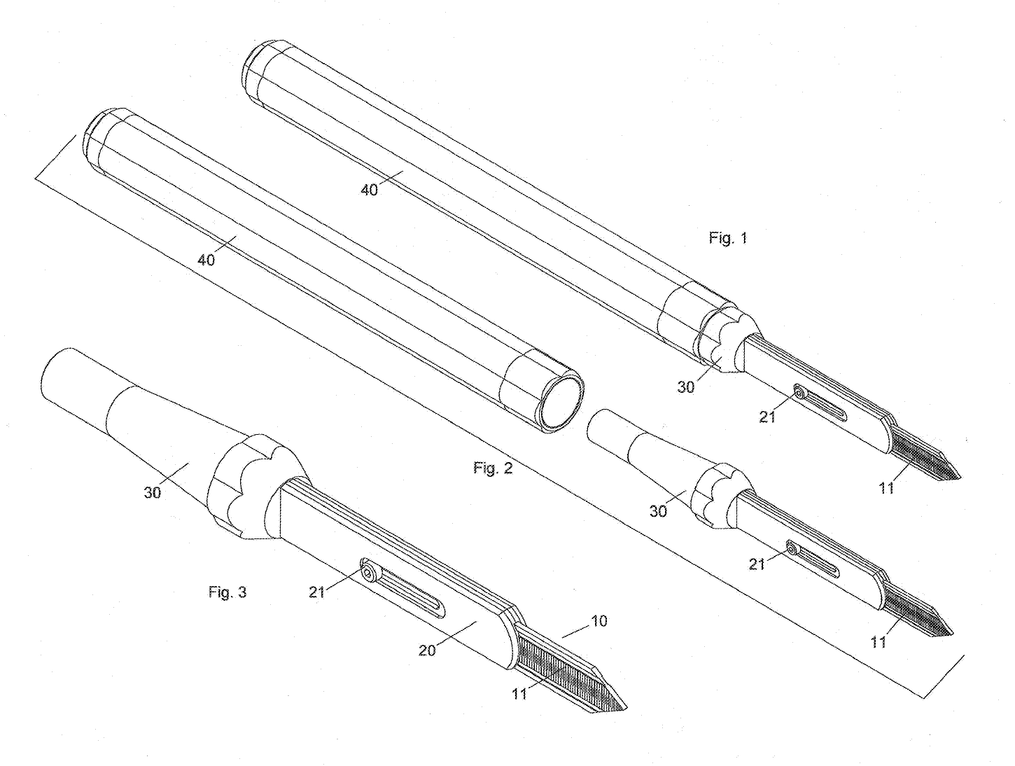

FIG. 1 illustrates an isometric perspective view of a complete parting tool. FIG. 2 illustrates an isometric perspective view showing the separation of a cutting blade assembly and bolster 30 from a handle 40. FIG. 3 illustrates a closer isometric perspective view showing a cutting blade 10, with indexed depth markings 11 in a cutting blade housing 20, held together by a cutting blade securing bolt 21 forming the cutting blade assembly which is held in a bolster 30. The indexed depth markings 11 on the cutting blade 10 can be as shown, or of any other variety of equally distanced marking The indexed depth markings 11 on the cutting blade 10 can also be present one or more sides of the cutting blade 10.

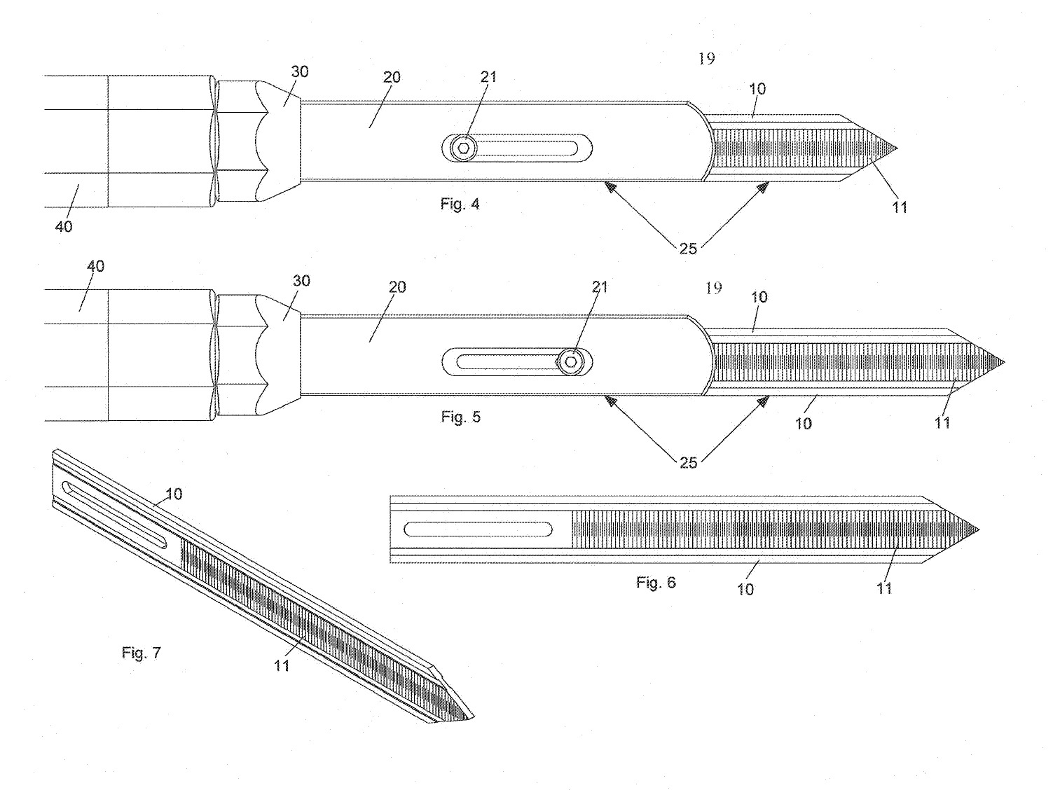

FIG. 4 illustrates a side view of a parting tool with a cutting blade fully retracted. FIG. 5 illustrates a side view of a parting tool with a cutting blade fully extended. FIG. 6 illustrates a side view of a cutting blade 10 with indexed depth markings 11. From FIGS. 4 and 5 it can be seen that the cutting blade 10 can extend and retract from the cutting blade housing 20 allowing different depths of cuts to be made. FIG. 7 illustrates an isometric perspective view of a parting tool cutting blade 10 with indexed depth markings 11.

From FIGS. 4 and 5 it can be seen that the bottom side of the cutting blade assembly 25 is coplanar, thus providing uninhibited movement of the parting tool across a tool rest as it enters the rotating workpiece. The coplanar nature of the cutting blade assembly also significantly increases the stability of the cutting blade by maintaining it in a vertical plane, thereby allowing the user to make cleaner and more precise vertical cuts. The coplanar bottom sides of the cutting blade assembly also give the cutting blade assembly a wider base, thereby significantly reducing vibration. These attributes of stability, uninhibited movement, accuracy of depth measurement, and low vibration are important because parting tools are primarily used to make clean vertical cuts.

The ability to adjust the length of extension of the cutting blade 10 beyond the asymmetrical distal end of a cutting blade housing 19 allows for easy and accurate measurement of the depth of the cut to be made as the cutting blade 10 will not cut deeper than the cutting blade housing 20. The asymmetrical nature of the distal end of the cutting blade housing 19 allows the indexed depth markings 11 to be seen easier as at least a portion of the indexed marking will be visible; additionally, the curvature of the asymmetrical distal end of the housing helps to provide a consistent cutting depth when the horizontal axis of the cutting blade is not coplanar with the horizontal axis of a workpiece.

The ability of the cutting blade 10 to extend also greatly increases the usable lifespan of the blade as it can extend after having been worn down by repeated sharpening. Additionally, the cutting blade's usable lifespan can be increased by making the blade of of a highly durable material such as 400-series stainless steel, or Vanadium.

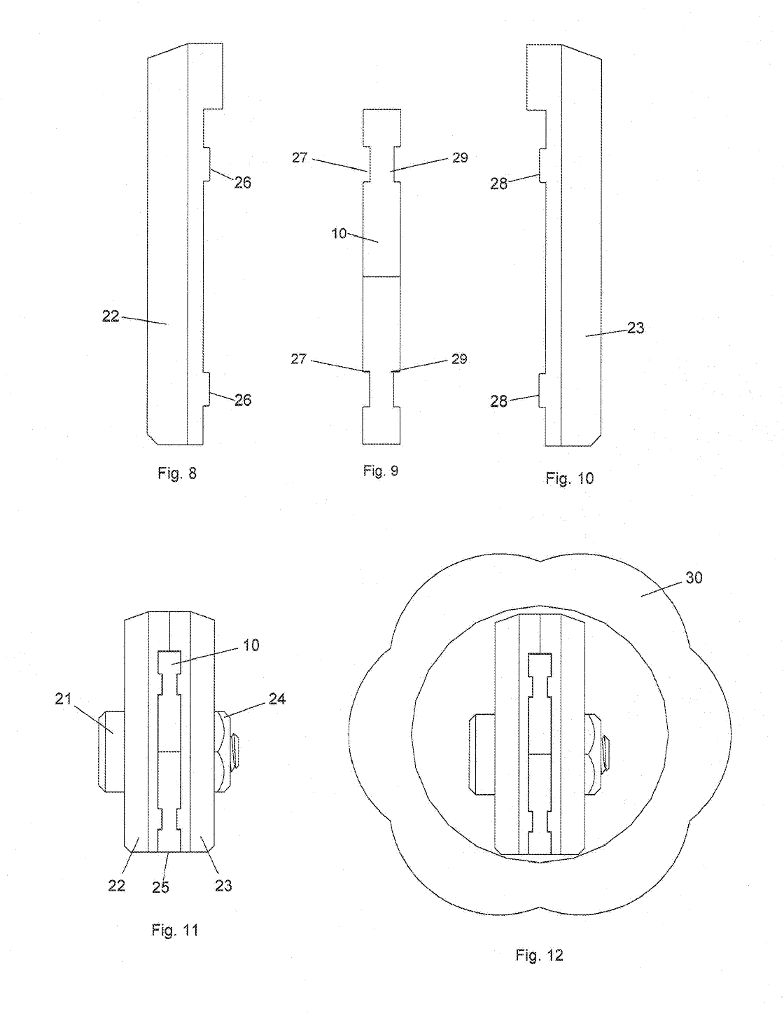

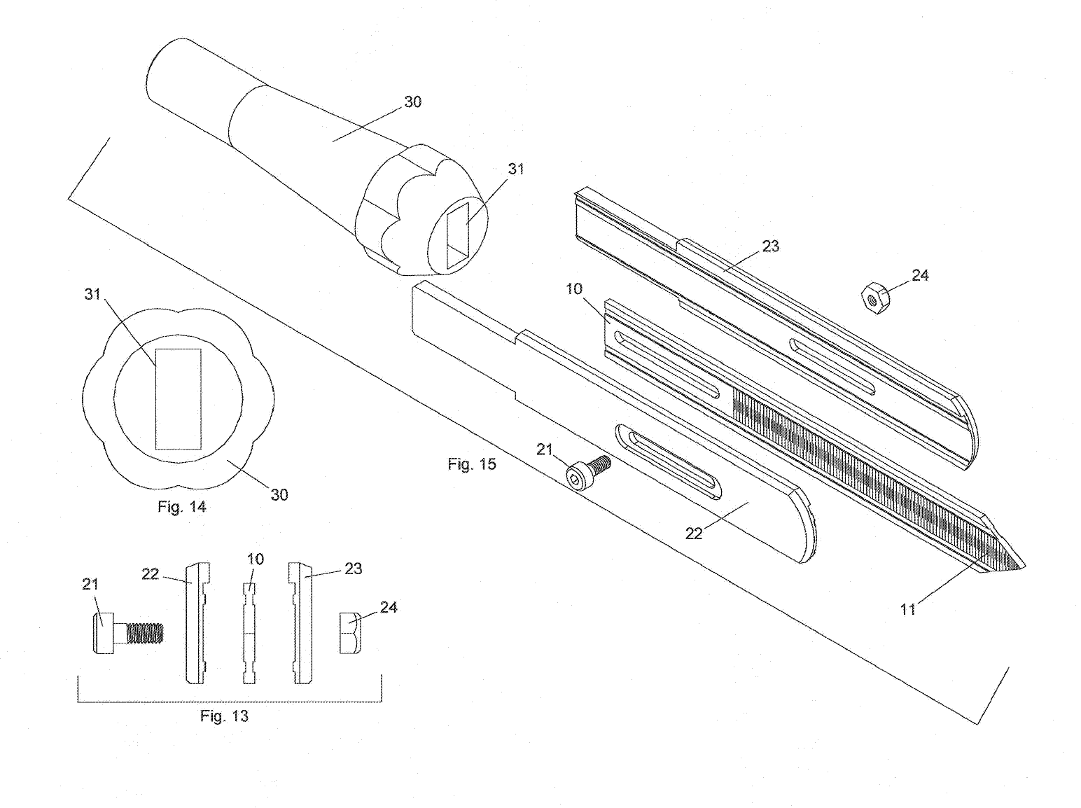

FIG. 8 illustrates the distal end view of a cutting blade housing's right face 22, the right side cutting blade housing's locating ribs 26 which secure the cutting blade's right side locating grooves 27. FIG. 9 illustrates a distal end view of a cutting blade 10. FIG. 10 illustrates the distal end view of a cutting blade housing's left face 23, the cutting blade housing's left face has locating ribs 28 that secure the cutting blades left side locating grooves 29, these interlocking ribs and grooves dampen vibration along the cutting blade assembly as well assist in securing the cutting blade 10 in the cutting blade housing 20. The interlocking ribs and grooves may be reversed in orientation or greater or fewer in number so long as they interlock. FIG. 11 illustrates the distal end view of a cutting blade assembly. FIG. 12 illustrates the distal end view of a cutting blade assembly secured in a bolster 30.

From FIGS. 11 and 12 you can see how the cutting blade securing bolt 21 attaches to the cutting blade securing nut 24, securing the cutting blade assembly with the help of the interlocking ribs and grooves. This configuration allows for easy replacement of the cutting blade 10 after completion of its useful lifespan, as well as the utilization of alternate blades for changing the available range of cutting depths. In other embodiments, alternate cutting blade housings can be shaped to hold longer, taller, or wider cutting blades and still fit the same bolster 30.

FIG. 13 illustrates an exploded distal end view of a cutting blade assembly. FIG. 14 illustrates a distal end view of a bolster 30 showing a mortise 31 for attachment of the cutting blade assembly. Additionally, the bolster 30 provides structural support to the cutting blade assembly, further dampening vibration from the cutting blade and reducing the transfer of vibration to the handle. The bolster may be made of a vibration dampening material, such as a pearlitic matrix flake graphite cast iron thereby fortifying the strength of the tool, or any other suitable material known to dampen vibration in the art. FIG. 15 illustrates an exploded isometric perspective view of a cutting blade assembly and a bolster 30. From this view you can see that the bolster provides a means for removable attachment of alternate cutting blade assemblies to handles of alternate diameters or lengths based on user preference. The bolster can be fitted into handles utilizing an internal threaded connection or some other connection mechanism.

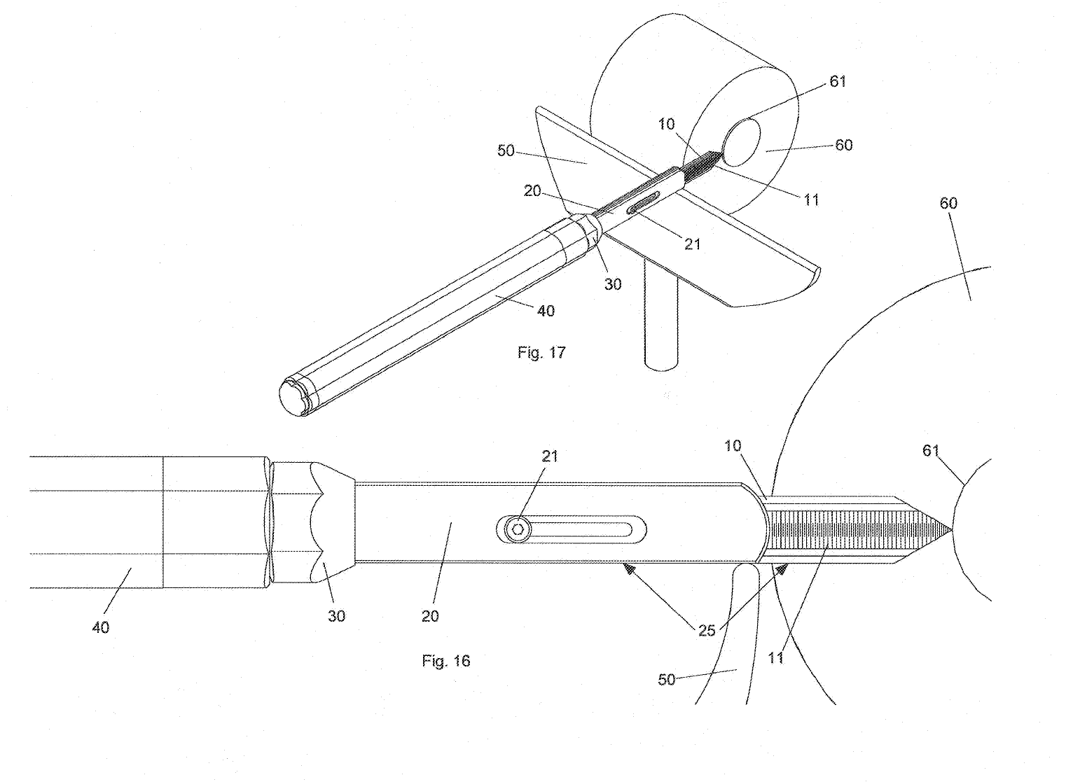

FIG. 16 illustrates a side view of a parting tool in use, resting on a tool rest 50, and cutting a tenon 61 on the end of a wooden workpiece 60. FIG. 17 illustrates an isometric perspective view of a parting tool in use, resting on a tool rest 50, and cutting a tenon 61 on the end of a wooden workpiece 60.

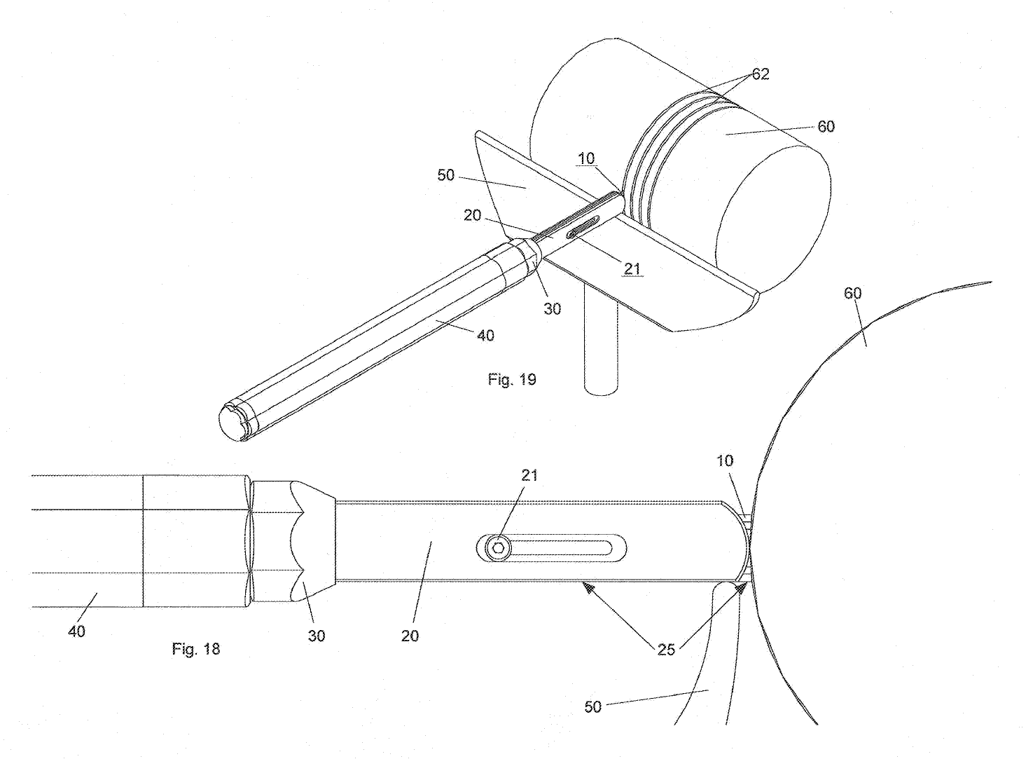

FIG. 18 illustrates a side view of an embodiment of the parting tool cutting a slot to a specific depth. FIG. 19 illustrates an isometric perspective view of a parting tool cutting slots 62 to a specific depth.

The parting tool described herein can be manufactured by forming a blade of any one of various heights, widths, lengths, cutting edges, and materials by various means; including, but not limited to: milling, electrical discharge machining, extrusion, and/or grinding. The cutting blade can be heat treated to optimal woodturning properties before or after machining depending on the choices of material and assembly method. The cutting blade may be made of highly durable material, such as 400-series stainless steel, Vanadium, or any other durable material suitable for its purpose. Either one or multiple indexes may be applied to either one or multiple sides of the cutting blade. The cutting blade housing can be machined as a whole or in pieces and brazed together. The cutting blade housing and cutting blade can be made to have coplanar bottom sides. The cutting blade housing can also be made with an asymmetrical distal end which may be curved. Brazing the cutting blade holding pieces into a singular cutting blade holder will dampen the vibration of the parting tool while in use and make replacement of the cutting blade easier.

The cutting blade is then housed in the cutting blade housing and can be clamped into place with a nut and bolt; or by any other means for securing the blade between the side faces. At this point the cutting blade assembly can be inserted into a mortise in a bolster. The bolster can then be attached to a handle with threaded receptacle or any other means common to the art.

Additionally, various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

### CONCLUSION

This parting tool comprises: a cutting blade housing or housing pieces, a moveable and replaceable cutting blade with indexed depth markings, a stabilizing bolster, and a removable handle. The easily readable indexed cutting blade and cutting blade housing allow for easy and precise depth of cut with the tool. The asymmetrical distal end of the cutting blade housing allows for easy reading of the indexed markings on the cutting blade. The blade is positioned in the housing pieces such that the bottom faces of the housing pieces and blade are all coplanar, thus providing uninhibited movement of the tool on the lathe tool rest as it enters the rotating workpiece and dampening the vibration. The cutting blade housing and bolster also allow for the accommodation and quick replacement of cutting blades and handles.

While my above description contains many specificities; these should not be construed as limitations on the scope of the invention, but rather as an exemplifications of one preferred embodiment thereof. Many other variations are possible. Accordingly, the scope of this invention should be determined not by the embodiments, but by the applied claims and their legal equivalents.

What is claimed is:

1. A parting tool, the parting tool comprising:
a cutting blade having multiple sides, wherein the cutting blade has indexed markings extending along its length on at least one side;
a cutting blade housing having multiple sides, wherein the cutting blade is housed;
a means for securing the cutting blade to the cutting blade housing that allows the cutting blade to be extended, retracted, and removed from the cutting blade housing; and
a handle.

2. The parting tool of claim 1, wherein the bottom side of the cutting blade and the cutting blade housing are coplanar.

3. The parting tool of claim 1, wherein the cutting blade housing has an asymmetrical distal end, said asymmetrical distal end allowing the indexed markings on the cutting blade to be easily read.

4. The parting tool of claim 3, wherein the asymmetrical distal end of the cutting blade housing is curved.

5. The parting tool of claim 1, wherein the cutting blade housing comprises two pieces.

6. The parting tool of claim 1, wherein the cutting blade housing and cutting blade have interlocking ribs and grooves that assist in securing the cutting blade in the cutting blade housing.

7. The parting tool of claim 1, wherein the cutting blade comprises of a highly durable material.

8. The parting tool of claim 1, also comprising a bolster, wherein the bolster can be removably attached to both the cutting blade housing and the handle.

9. The parting tool of claim 8, wherein the bolster comprises a vibration dampening material.

10. A method for manufacturing a parting tool, comprising:
forming a cutting blade with multiple sides;
putting indexed markings along the length of at least one side of the cutting blade;
forming a cutting blade housing having multiple sides, wherein the cutting blade is housed;
inserting the cutting blade into the cutting blade housing;
securing the cutting blade in the cutting blade housing such that the cutting blade can be extended, retracted, and removed from the cutting blade housing;
forming a handle; and
removably attaching the cutting blade housing to the handle.

11. The method of claim 10, wherein the bottom side of the cutting blade housing is formed to be coplanar with the bottom side of the cutting blade.

12. The method of claim 10, wherein forming the cutting blade housing comprises forming an asymmetrical distal end.

13. The method of claim 12, wherein forming the cutting blade housing comprises machining an asymmetrical distal end that is curved.

14. The method of claim 10, wherein forming the cutting blade housing comprises forming two or more cutting blade housing pieces.

15. The method of claim 14, wherein forming the cutting blade housing comprises brazing the cutting blade housing pieces together.

16. The method of claim 10, wherein forming the cutting blade housing and cutting blade comprises forming interlocking ribs and grooves on the cutting blade and cutting blade housing that assist in securing the cutting blade in the cutting blade housing.

17. The method of claim 10, wherein forming the cutting blade comprises using a highly durable material.

18. The method of claim 10, wherein the removable attachment of the cutting blade housing to the handle comprises:
forming a bolster;
removably attaching the cutting blade housing to the bolster;
removably attaching the bolster to the handle.

19. The method of claim 18, wherein forming the bolster comprises using a vibration dampening material.
